(19) United States
(12) Patent Application Publication
(10) Pub. No.: US 2024/0380439 A1
(43) Pub. Date: Nov. 14, 2024

(54) SYSTEMS AND METHODS USING REFLECTION-BASED COMMUNICATION ELEMENTS

(71) Applicant: ZTE Corporation, Shenzhen (CN)

(72) Inventors: Qian DAI, Shenzhen (CN); Zhiyong ZHAO, Shenzhen (CN); Ping LI, Shenzhen (CN)

(73) Assignee: ZTE Corporation, Shenzhen (CN)

(21) Appl. No.: 18/781,612

(22) Filed: Jul. 23, 2024

Related U.S. Application Data
(63) Continuation of application No. PCT/CN2022/074251, filed on Jan. 27, 2022.

(51) Int. Cl. H04B 7/04; H04W 8/22; H04W 48/14

(52) U.S. Cl. CPC H04B 7/04013; H04W 8/22; H04W 48/14

(57) ABSTRACT

Embodiments of a system, device and method for designing or configuring reference signaling are disclosed. In some aspects, a wireless communication method includes sharing, by a first wireless communication node and a second wireless communication node, a reflection-based communication element.

### CROSS-REFERENCE TO RELATED APPLICATION

This application claims the benefit of priority under 35 U.S.C. § 120 as a continuation of International Patent Application No. PCT/CN2022/074251, filed on Jan. 27, 2022, the disclosure of which is incorporated herein by reference in its entirety.

### TECHNICAL FIELD

The disclosure relates generally to wireless communications and, more particularly, to systems and methods for designing or configuring reference signaling.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

Embodiments of a system, device and method for designing or configuring reference signaling are disclosed. In some aspects, a wireless communication method includes sharing, by a first wireless communication node and a second wireless communication node, a reflection-based communication element.

In some aspects, a wireless communication method includes receiving, by a reflection-based communication element from a first wireless communication node, a sharing configuration to indicate sharing of the reflection-based communication element by a plurality of wireless communication nodes.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques and other aspects disclosed herein may be implemented, in accordance with an embodiment of the present disclosure.

FIG. 2 illustrates block diagrams of an example base station and a user equipment device, in accordance with some embodiments of the present disclosure.

FIG. 3A illustrates a block diagram of exemplary coverage areas of multiple base stations, in accordance with some embodiments of the present disclosure.

FIG. 3B illustrates a block diagram of a system including a RIS/repeater management function, in accordance with some embodiments of the present disclosure.

FIG. 4 illustrates a swim lane diagram of an exemplary process for obtaining RIS capabilities, in accordance with some embodiments of the present disclosure.

FIG. 5 illustrates a block diagram of exemplary multiple base stations with RISs deployed at the edge of each cell, in accordance with some embodiments of the present disclosure.

FIG. 6 illustrates a swim lane diagram of an exemplary Xn setup process, in accordance with some embodiments of the present disclosure.

FIG. 7 illustrates a swim lane diagram of an exemplary newly defined Xn process, in accordance with some embodiments of the present disclosure.

FIG. 8 illustrates a swim lane diagram of an exemplary process for initiating the process of sharing RIS between neighboring base stations, in accordance with some embodiments of the present disclosure.

FIG. 9 illustrates a swim lane diagram of another exemplary process for initiating the process of sharing RIS between neighboring base stations, in accordance with some embodiments of the present disclosure.

FIG. 10 illustrates a swim lane diagram of an exemplary process for base station information forwarding during sharing, in accordance with some embodiments of the present disclosure.

FIG. 11 illustrates a swim lane diagram of an exemplary process for modifications shared by RIS, in accordance with some embodiments of the present disclosure.

FIG. 12 illustrates a swim lane diagram of an exemplary process for withdrawal of RIS sharing, in accordance with some embodiments of the present disclosure.

FIG. 13 illustrates a swim lane diagram of an exemplary process for commencement of RIS/repeater sharing, in accordance with some embodiments of the present disclosure.

FIG. 14 illustrates a method 1400 for sharing a reflection-based communication element, in accordance with some embodiments.

FIG. 15 illustrates a method 1500 for receiving a sharing configuration to indicate sharing of a reflection-based communication element, in accordance with some embodiments.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### A. Network Environment and Computing Environment

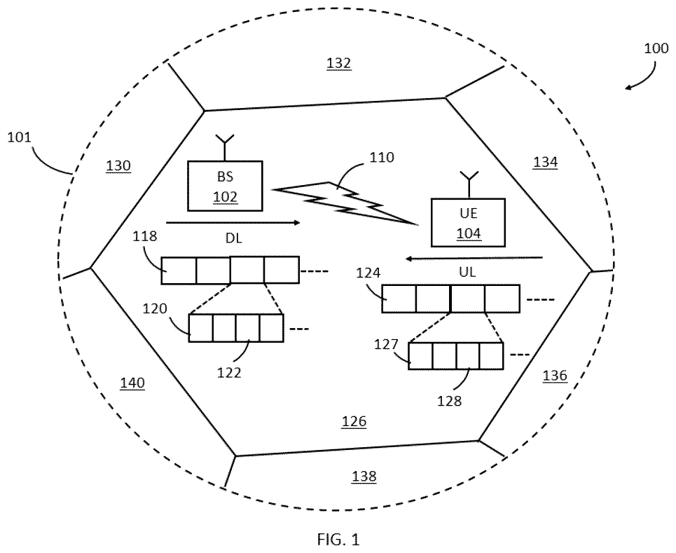

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

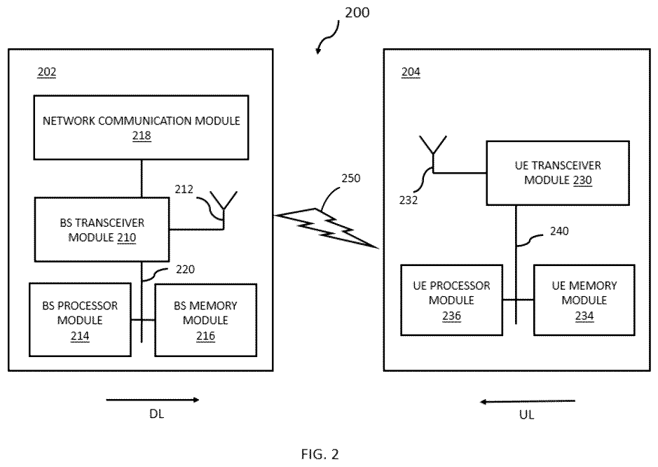

FIG. 2 illustrates a block diagram of an example wireless communication system 200 for transmitting and receiving wireless communication signals, e.g., OFDM/OFDMA signals, in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

### B. Reference Signaling Design and Configuration

A scenario where multiple base stations (BS, e.g., the BS 102, the BS 202, a next generation NodeB (gNB), an evolved NodeB (eNB), a wireless communication node, a cell tower, a 3GPP radio access device, a non-3GPP radio access device, a network node, etc.) share the same RIS (Reconfigurable Intelligent Surface, intelligent reflective surface) is not disclosed in the prior art. Disclosed herein are embodiments of a system, device, and method to negotiate between base stations in this scenario, share RIS methods, processes, interactive parameters, types of RIS and other issues.

With the explosive growth of data traffic, millimeter wave (mmWave) is used in the fifth generation of mobile communications due to the abundance of available frequency bands in mmWave. One challenge to realize millimeter wave communication is path loss. In order to compensate for the serious path loss of millimeter wave transmission, millimeter wave base stations (BS, Base Station) can use large-scale antenna arrays for narrow beam transmission, which can effectively transmit energy directed in a certain area or direction. However, millimeter-wave directional transmission can be sensitive to congestion and can even cause connection interruption, which brings new challenges to the establishment and maintenance of millimeter-wave links. To this end, the Reconfigurable Intelligent Surface (RIS) is integrated into the millimeter wave cellular system.

RIS is an antenna surface that contains a large number of (low-cost) passive reflective elements, in some embodiments. Each element can independently adjust the phase and amplitude of the incident electromagnetic wave, thereby changing the propagation path of the electromagnetic wave. Traditional wireless technology can perform signal processing at the transceiver end to adapt to a dynamic and uncontrollable wireless environment, while RIS can (actively, intelligently, etc.) correct the wireless channel through a controllable intelligent signal reflection technology. Therefore, RIS can provide a new degree of freedom for improvement of wireless link performance and may pave the way for the realization of an intelligent programmable wireless environment. In the millimeter wave cellular system, the congestion problem can severely reduce the communication quality and even cause the link to be interrupted. With its ability to change the electromagnetic wave transmission environment, RIS may become a new method to deal with the problem of millimeter wave communication congestion. For users whose links with the base station are blocked, the phase of RIS can be adjusted to enable a transmission path of electromagnetic waves to bypass obstructions to reach users, thereby improving the communication quality and the coverage of the millimeter wave system.

Some embodiments of a deployment method of RIS adopt the deployment of one or more dedicated RISs in the coverage area of a single base station to improve the signal of coverage blind spots in the coverage area of the base station. However, the blind spots covered by RIS may have a distinction between busy and idle periods. When the RIS is in a non-working state or only uses part of the resources, it can cause the resources to be idle. Therefore, how to fully and efficiently use RIS is a problem that needs to be solved.

Some wireless communication systems may support the use of wireless repeaters. For example, a wireless repeater may be located between a UE and relay the communications between the base station and UE. Repeaters are used to enhance the coverage area of a transmitting device. The repeater may not attempt to decode the signal, but may receive an RF signal over the air, amplify it and re-transmit it. Sometimes the repeater's configuration, e.g., using to control the re-transmitted signal direction and width, can be controlled by the base station to achieve flexible repeater usage. The use case and function of repeater may be similar to RIS. A difference may be that RIS does not amplify the RF signal which can save device cost, and, in some cases, may use larger size reflective panel to ensure the RF signal strength.

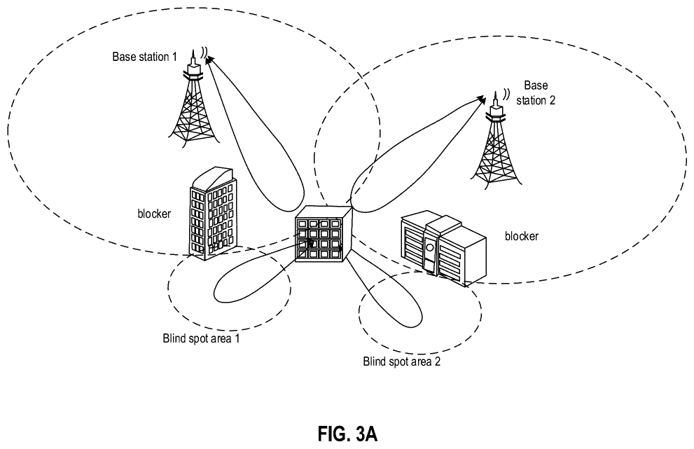

Disclosed herein are embodiments of a system, device, and method for multiple base stations to share the use of RIS. FIG. 3A illustrates a block diagram of exemplary coverage areas of multiple base stations, in accordance with some embodiments of the present disclosure. When there are multiple blind spots near the overlapping area of two or more base station coverage areas, RIS can be deployed in the overlapping area, and two or more base stations can share and use the RIS, as shown in FIG. 3A.

Since base station 1 (BS1) and base station 2 (BS2) may have different coverage requirements and beam configurations when covering their respective blind spot areas, different base stations such as BS1 and BS2 may use RIS in different ways, resource requirements, and delay requirements.

In some embodiments, a BS acquires RIS sharing capabilities. Communication between neighboring BSs can include: support shared RIS information (RIS type, RIS location, RIS sharing capability (sharing pattern), RIS terminal identification, and RIS user interface working status (on/off)). A neighboring BS can initiate the process of sharing RIS. In some embodiments, during the (initiation) period, the sharing mode is negotiated, the configuration parameters are shared, and during the sharing period, the control module of the RIS establishes a link with which BS. Other auxiliary processes include: modification process of sharing mode, exit process of sharing mode, failure process of sharing mode, and suspended process of sharing mode.

FIG. 3B illustrates a block diagram of a system including a RIS/repeater management function, in accordance with some embodiments of the present disclosure.

The RIS/repeater management function can be a (software) logical entity and can be located in the operation management and maintenance (OAM) background of the network operator. The RIS/repeater management function can be managed and used by the network operator to: provide RIS configuration parameters (parameters other than shared configuration parameters); decide which BS can share which RIS/repeater; configure shared configuration parameters for the target RIS/repeater.

The RIS/repeater management function can determine a policy (e.g., plan, scheme, etc.) for sharing the RIS/repeater. A BS can determine a different policy for sharing the RIS/repeater. The two policies can exist in parallel. A core of the weight can be adjusted at the RIS-BS interface.

The RIS/repeater can receive a shared configuration (message) from network nodes. The shared configuration can be obtained by the network node from the RIS/repeater management function. Other network nodes participating in the sharing can obtain the shared configuration from the RIS/repeater management function (that is, the management function can send the shared configuration to each BS participating in the sharing). For the shared configuration received, the network node can feedback to the RIS/repeater management function one or more of: an indication of a rejection, carrying the reason for rejection, such as: wrong configuration parameters, unsupported configuration parameters, unreachable RIS/repeater (unreachable, meaning unable to connect); an indication of receipt; an indication that the RIS/repeater configuration is successful: that is, the shared configuration is successfully configured to RIS/repeater; an indication of modification: suggestions for modification of shared configuration.

Additionally or alternatively, the shared configuration can be negotiated between the network node and another network node participating in the sharing.

The shared configuration (message) includes one or more of: the identifier of the shared RIS/repeater; the identifier(s) of the network nodes participating in the sharing; the shared mode adopted; the configuration parameters corresponding to the shared mode; while the sharing mode is enabled, which network node the RIS/repeater control module camps on by default; or reflection element array codebook configured for RIS by each network node. The identifier of the shared RIS/repeater indicates which RIS/repeater of the network node is used for sharing. The one or more identifiers of the network nodes participating in the sharing indicate which network nodes share and use the RIS/repeater. Shared mode can include mode 1 or mode 2. Mode 1: during the entire sharing mode, if the RIS/repeater control module camps on a fixed network node (that is, it means that the updated parameters are always issued to RIS/repeater through the network node), the identifier of the network node is provided. Mode 2: during the sharing mode, which network node is to use the RIS/repeater, then which network node the control module of the RIS/repeater camps on.

A network node and/or RIS/repeater management function can acquire RIS capabilities. Network nodes can obtain RIS capabilities from the core network or from RIS. Prior to the network nodes acquiring RIS capabilities, RIS can report to the wireless communication network node or wireless communication core network about the capabilities related to sharing. The network node can include the wireless communication base station.

The ability to obtain RIS from RIS can include: the network node sending a capability query request to RIS, which specifies the type of capability that RIS is required to report; or the RIS reporting the corresponding capability information according to the capabilities requested by the network node.

RIS and sharing-related capabilities can include the RIS type. The RIS type can include one or more of: whether there is there power supply for the RIS reflective panel; working modes supported by RIS; whether the RIS is a single-reflective panel or a multi-reflective panel; whether each reflective panel of RIS can be divided into multiple sub-reflecting surfaces; whether the RIS has a control module for controlling the reflective panel; the configuration mode of the antenna reflector array codebook supported by RIS; RIS panel physical parameters; or whether the RIS control module supports multiple connections, which can refer to the ability to establish communication links with multiple network nodes at the same time.

Working modes supported by RIS can include, but is not limited to: transmission mode, reflection mode, and partial reflection mode (partial transmission, partial reflection). If RIS is a multi-reflective panel, the number of multi-reflective panels can be included in the RIS type.

If each reflective panel of RIS can be divided into multiple sub-reflecting surfaces, the RIS type can include, but is not limited to: the number and shape of the sub-reflecting surfaces, the number of reflecting units contained in the sub-reflecting surfaces, and the working mode of the sub-reflecting surfaces.

The control module has the function of communicating with wireless network nodes, as well as the function of controlling the working mode of the reflective panel and the function of the reflective unit. The control reflection unit can include, but is not limited to: the amplitude control target, phase control target, frequency control target, and polarization control target of the incident wave of the control reflection unit

The configuration mode of the antenna reflector array codebook supported by RIS can include: dynamic, semi-static, and static; and the supported configuration parameter update interval. RIS panel physical parameters can include: aperture, reflection unit density, frequency characteristics, supported bandwidth, reciprocity characteristic information, degree of difference in each direction, and adjustable angle interval. Whether the RIS control module supports multiple connections can refer to the ability to establish communication links with multiple network nodes at the same time.

RIS and sharing-related capabilities can include one or more sharing modes supported by RIS. The one or more sharing modes supported by RIS one or more of: time sharing; frequency division sharing; or air separation sharing. RIS can have multi-reflective panels, and different panels can serve different network nodes.

The RIS can report the capability information to the network. The RIS reporting to the network can include reporting to one or more of the wireless communication core network or the wireless communication base station.

Communication between adjacent network nodes can include the information within its coverage area that can support the shared RIS. A Network node 1 and a network node 2 can exchange RIS information within their own coverage or connectable. The RIS information includes one or more of: RIS identification; RIS type; RIS location; RIS sharing mode; the working status of the RIS reflective panel (on/off); free RIS resources; or measurement results of network nodes reported by RIS. The RIS identification can uniquely distinguish the RIS identity in the cellular network, and can be distinguished from other RIS and UE (user equipment, e.g., the UE 104, the UE 204, a mobile device, a wireless communication device, a terminal, etc.) based on this. For example, the UE ID of the RIS control module can be used, such as IMSI (International Mobile Subscriber Identification Number, International Mobile User identification code, corresponding to mobile user identity, namely SIM card identity), IMEI (International Mobile Equipment Identity mobile equipment international identity code, corresponding to terminal equipment identity), S-TMSI (SAE-Temporary Mobile Subscriber Identity, temporary UE identification number, by Core network allocation), GUTI (Globally Unique Temporary UE Identity, globally unique temporary UE identity, allocated by the core network), or use a newly defined identity.

The manner in which network node 1 and network node 2 exchange the RIS information can include Xn setup process through an Xn interface or a newly defined process through the Xn interface.

The process of sharing RIS between adjacent network nodes (network nodes including BS) can include negotiating a sharing mode, sharing configuration parameters, and which BS the RIS control module establishes a link with during the sharing period.

The process of sharing RIS can include the optional process 1, in which BS2 can send a sharing request to BS1, requesting to share the target RIS covered by BS1. BS2 can determine whether it needs to use the RIS covered by BS1 based on the information previously communicated with BS1 that can support the sharing of RIS. If so, BS2 can initiate the optional process 1.

Step 1: BS2 can send a sharing request to BS1, and the information it carries can include one or more of: identification of one or more target RIS; the (one or more) sharing mode(s) of the target RIS; shared configuration parameters of the target RIS; during the period when BS2 uses the target RIS, whether the target RIS is connected to BS1 or BS2 or is connected to BS1 and BS2 at the same time (the RIS control module may support at least dual connections); or optionally, reflect element array codebook for RIS configuration.

Step 2: BS1 can determine (e.g., decide) whether to accept the sharing request. If so, it can feed back the acceptance message to BS2, and confirms or modifies the sharing information required by BS2. The acceptance message can include one or more of: indication of accepted identity of one or more target RIS shared; the identification of one or more target RISs that refuse to share, optionally with a reason for rejection (e.g., the target RIS does not support the sharing mode or shared configuration parameters required by BS2, and the target RIS lacks sharable resources); indication of accepted or modified target RIS sharing mode; indication of accepted or modified shared configuration parameters of the target RIS; or, while BS2 is using the target RIS, whether the control module of the target RIS is connected to BS1 or BS2 or is connected to BS1 and BS2 at the same time (the RIS control module may support at least dual connections).

Step 3: BS1 can send one or more (shared) configuration messages to the shared RIS (e.g., the RIS that accepts sharing). The shared configuration message is described above.

Step 4: RIS can perform sharing according to the configuration message.

The process of sharing RIS can include the optional process 2, in which BS1 can send an inquiry to BS2 to inquire whether BS2 has a need to share a certain RIS. BS1 can determine whether to initiate the inquiry process based on the reference signal measurement result of BS2 in the measurement report reported by RIS and the utilization rate of RIS resources by BS1. If so, BS1 may initiate the optional process 2.

Step 1: BS1 can send an inquiry message (e.g., RIS sharing message) to BS2 to inquire whether BS2 has a need to share a certain RIS. The content of the message may include one or more of: the identification of one or more target RISs that can be shared; (one or more) shared mode(s) that the target RIS can support; shared configuration parameters that the target RIS can support; or, during the period when BS1 uses the target RIS, whether the control module of the target RIS is connected to BS1 or BS2 or is connected to BS1 and BS2 at the same time (the RIS control module can be required to support at least dual connections).

Step 2: BS2 can determine whether it needs to use shared RIS (for example, based on whether there are blind spots in its own coverage area and whether the shared RIS can cover the blind spots). If so, BS2 can send a feedback message to BS1 indicating that it needs to be shared, and includes BS2 selection, the shared RIS, and corresponding parameters. The message content may include one or more of: one or more target RIS logos (e.g., identification, serial number, etc.) selected to join the sharing; the sharing mode adopted by the target RIS; shared configuration parameters adopted by the target RIS; during the period when BS1 uses the target RIS, whether the control module of the target RIS is connected to BS1 or BS2 or is connected to BS1 and BS2 at the same time (the RIS control module is required to support at least dual connections); or, optionally, reflect element array codebook configured by BS2 for RIS.

Step 3: BS1 can send (shared) configuration messages to the shared RIS. The shared configuration message is described above.

Step 4: RIS can perform sharing according to the configuration message. The shared configuration parameters corresponding to the shared mode may include the configuration parameters for time sharing, the configuration parameters of frequency division sharing, or the configuration parameters for air separation sharing.

The configuration parameters for time sharing include one or more of: shared time period information available to each network node participating in the sharing, or time point or time offset when the shared mode starts. Shared time period information can indicate that the time period can be periodic, wherein the shared time period information includes the period length, the available sharing duration in each period, and the available sharing time start time offset in each period. Shared time period information can indicate that the time period can be non-periodic, wherein the shared time period information includes a time period defined by the start time and end time. Shared time period information can include a time period defined by the start time and duration. Shared time period information can include granularity of the time period defined in hours, minutes, seconds, milliseconds, or defined by system frames, subframes, time slots, and symbols.

The configuration parameters of frequency division sharing can include one or more of: shared frequency band information or RIS reflecting unit array corresponding to the shared frequency band. The RIS reflecting unit array can be defined by the number of reflecting units or the range of rows and columns of reflecting units.

The configuration parameters for air separation sharing include one or more of: the number of shared reflective panels; shared reflective panel logo; the configuration mode of the antenna reflection unit array codebook of the shared reflection panel: dynamic, semi-static, static, or, optionally, supported configuration parameter update time interval; or the physical parameters of the shared reflective panel and the size of the reflective unit array.

During the RIS sharing period, BS1 or BS2 can decide whether to send an updated reflect unit array codebook to RIS as needed. For example, if BS2 decides to send the updated codebook of the reflector array to RIS, but the current control module of RIS is connected to BS1 and not BS2, then BS2 can send the updated codebook to RIS through the base station interface BS1 and BS1 can forward the codebook to RIS.

Shared establishment failure process can include that, if the sharing mode negotiated by BS1 and BS2 requires RIS to access BS2, when RIS fails to access BS2, the failure process can be triggered, and the sharing process for the target RIS can end. The failure process can include the RIS sending a message to notify BS1 of the failure and/or the reason for the failure or BS2 informing BS1 of the failure and/or the reason for the failure through the interface between base stations. The failure process can include the end of the sharing process for the target RIS.

Shared establishment failure process can include, if BS2 fails to send configuration parameters to the shared RIS or the configuration fails, triggering the failure process, and ending the sharing process to the target RIS. The failure process can include, if the configuration parameters of BS2 to the shared RIS are sent directly through the air interface of BS2 and RIS and a failure occurs, BS2 informing BS1 of the failure and/or the reason for the failure. The failure process can include, if the configuration parameters of BS2 to the shared RIS are forwarded through the air interface of BS1 and RIS and a failure occurs, BS1 informing BS2 of the failure and/or the reason for the failure. The failure process can include that, if the RIS receives the configuration message but fails to decode the configuration message or the configuration parameters are incorrect and cannot be supported, the UE feeding back the configuration failure message and/or the reason for the failure to the sender BS of the message.

Shared establishment failure process can include, if the configuration parameters of BS2 for the shared RIS have been configured successfully, but BS2 does not receive the access of the UE within the coverage of the shared RIS, triggering the failure process, and ending the sharing process for the target RIS. The failure process can include BS2 informing BS1 of the failure and/or the reason for the failure through the interface between base stations.

RIS may execute the shared behavior according to the configuration message. If time sharing is adopted, RIS can use the reflection unit array codebook issued by the corresponding BS according to the received time sharing configuration parameters. That is, when BS1 uses RIS, RIS can use the configuration parameters issued by BS1 and the reflection unit array codebook. While BS2 uses RIS, RIS can adopt the configuration parameters issued by BS2 and the codebook of the reflective unit array. If time sharing is adopted, the control module of RIS can decide which BS to access according to the parameter/message “During BS1 using the target RIS, whether the control module of the target RIS is connected to BS1 or BS2.”

If frequency division sharing is adopted, RIS can work according to the received reflection unit array codebook, where the reflection unit array codebook can be generated by the base station according to the frequency division sharing configuration parameters and the RIS reflection unit array codebook provided by the two shared base stations. The reflection unit array codebook may contain the corresponding frequency bands used by the two shared base stations.

If air division sharing is adopted, RIS can configure the received configuration parameters and reflect unit array codebook to the corresponding reflector panels according to the received air division sharing configuration parameters.

Modification process shared by RIS includes that when BS1 or BS2 needs to modify one or more parameters in the shared mode or shared configuration of the RIS negotiated in advance, BS1 or BS2 can initiate the modification process to the other party. For example, when BS2 initiates the modification process, the steps include: BS2 sending a RIS sharing modification request to BS1; BS1 determining whether to accept the modification (if not, BS1 may feed back a rejection message (optional, with the reason for rejection), or, if so, BS1 may feed back an acceptance confirmation message); BS1 sending updated RIS shared configuration parameters to RIS; and RIS executing according to the received RIS shared configuration parameters.

The RIS sharing modification request can include one or more of: RIS logo that needs to be modified; optionally, the sharing mode that needs to be modified and/or the reason for modification; optionally, shared configuration parameters that need to be modified and/or reasons for modification; or, optionally, which BS is connected to RIS and/or the reason for modification.

The acceptance confirmation message can include one or more of: indication of accepting the revised RIS logo; optionally, indication of accepting the modified sharing mode; optionally, indication of accepting the modified shared configuration parameters; or optionally, indication of accepting modification and which BS is connected to RIS.

When BS1 or BS2 needs to suspend the sharing of the RIS negotiated in advance, BS1 or BS2 can initiate a sharing exit process to the other party. The steps of the initiation process (e.g., by BS2) can include: BS2 sending RIS sharing withdrawal request to BS1; BS1 feeding back a confirmation message; BS1 sending a RIS sharing exit message to the corresponding RIS; and RIS deleting the shared configuration parameters related to BS2 and stops the sharing operation.

The sharing withdrawal request can include one or more of: BS2 indicating that BS2 discontinues sharing RIS logo; or, optionally, the reason for discontinuing sharing (e.g., changes in own resource requirements, changes in blind spot coverage requirements, RIS coverage performance is not up to the requirements, business requirements changes).

The RIS sharing exit message may include one or more of: BS1 indicating that BS1 has exited the shared BS logo; optionally, the reason for discontinuing sharing; or optionally, BS1 indicating that BS1 has updated reflect unit array codebook.

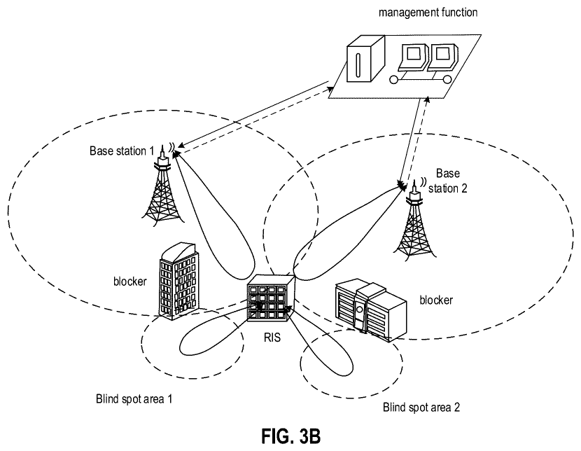

FIG. 4 illustrates a swim lane diagram of an exemplary process for obtaining RIS capabilities, in accordance with some embodiments of the present disclosure. In one embodiment, a 5G base station gNB obtains RIS capabilities in a scenario where RIS assists in improving blind spot coverage in a 5G NR network, as shown in FIG. 4.

When the RIS control module is initially attached to the 5G network, the RIS control module may need to (e.g., may be instructed/programmed to) report the UE capability to the core network node Access and Mobility Management Function (AMF) in the attach request, which can carry the RIS capability; the 5G base station gNB can be used in the subsequent UE initial context setup process (initial context setup). The core network can acquire RIS capabilities. Another way to obtain RIS capabilities can be to send UE capability query signaling to RIS by gNB, requesting RIS to report RIS capabilities, and RIS sending RIS capabilities to gNB through UE capability information.

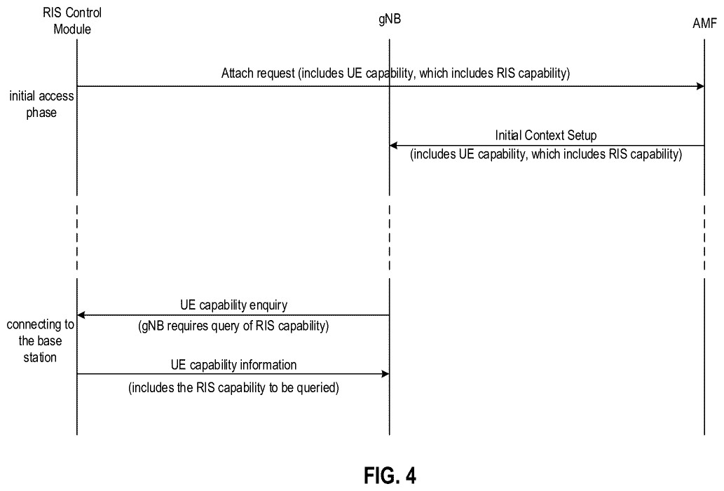

FIG. 5 illustrates a block diagram of exemplary multiple base stations with RISs deployed at the edge of each cell, in accordance with some embodiments of the present disclosure. In one example, a 5G network constructed by the 5G base station gNB. In order to cover blind spots, adjacent gNB1 and gNB2 may have deployed several RISs at the edge of the cell. The two gNbs can communicate with each other's RIS information to determine whether there is a shareable RIS, as shown in FIG. 5. RIS1, 2, and 3 can be deployed at the edge of the coverage of gNB1, and RIS4 and 5 can be deployed at the edge of the coverage of gNB2.

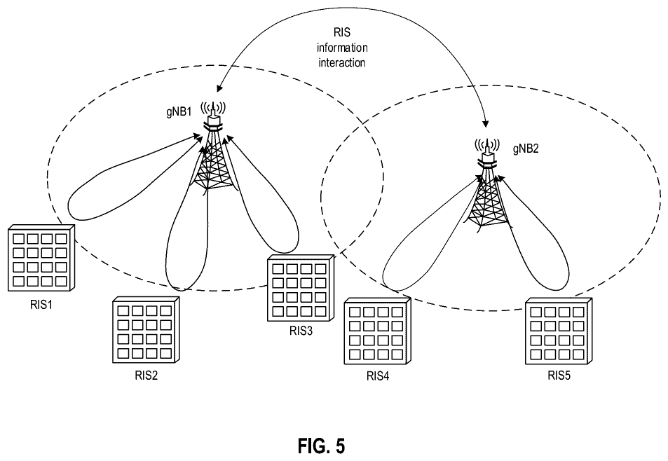

FIG. 6 illustrates a swim lane diagram of an exemplary Xn setup process, in accordance with some embodiments of the present disclosure. The gNB1 and gNB2 can interact with each other's RIS information through the establishment process of the interface Xn between base stations, and can also interact through other existing Xn interface procedures, or through new interface messages.

The Xn setup process can include gNB1 sending Xn setup request to gNB2, which carries the information of RIS1, 2, 3 within the coverage of gNB1; and gNB2 feeding back Xn setup response to gNB1, which carries the information of RIS4,5 within the coverage of gNB2;

The information of the Xn setup process can include one or more of: RIS identification; RIS type; sharing mode supported by RIS; RIS location information; the working state of the RIS reflective panel (whether it is in the power-on state or the off state); idle RIS resources; or measurement results of network nodes reported by RIS.

RIS identification can include an identification that can uniquely distinguish the RIS identity in the cellular network. Examples of unique identifiers, RIS type, and sharing mode supported by RIS are discussed above.

An example of idle RIS resources includes, for a RIS that supports time-division sharing, how much time the RIS have is non-working time; for a RIS that supports frequency-division sharing, which frequency band the RIS currently serves; for a multi-panel RIS, whether the RIS is free reflective panel.

Examples of measurement results of network nodes reported by RIS includes RIS's signal quality measurement results of each frequency point, and which frequency points are measured by the base station for RIS configuration.

The gNB1 or 2 can determine according to the RIS information: whether there is a RIS that it can use in the RIS of the neighboring area (e.g., whether the RIS type/capability can be supported, and whether the RIS can be covered). For example: if RIS3 has two reflective panels, but one reflective panel is idle, gNB2 may determine whether its coverage area has blind spots in the reflective area of RIS3. If so, one of the gNBs (e.g., gNB2) can request the sharing of RIS3 to cover the blind spots.

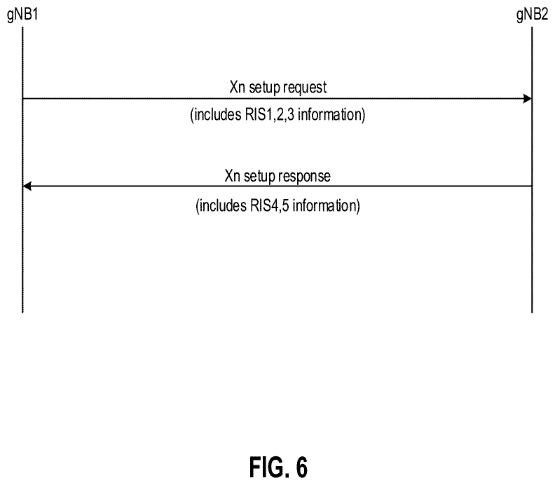

FIG. 7 illustrates a swim lane diagram of an exemplary newly defined Xn process, in accordance with some embodiments of the present disclosure. In addition to using the Xn setup process to exchange RIS information, one of the gNBs can use other existing NR processes to exchange RIS information, such as: NG-RAN NODE CONFIGURATION UPDATE process or RESOURCE STATUS REQUEST. One of the gNBs can define a new process in the Xn interface, as shown in FIG. 7.

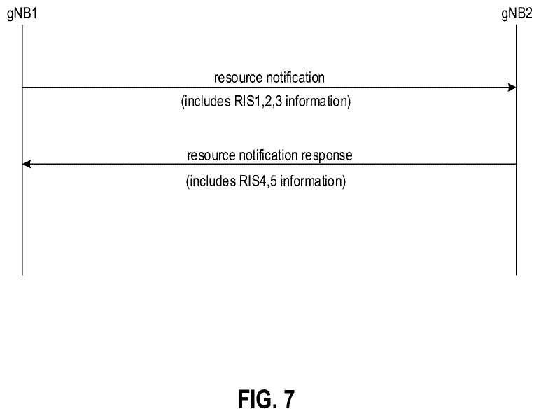

FIG. 8 illustrates a swim lane diagram of an exemplary process for initiating the process of sharing RIS between neighboring base stations, in accordance with some embodiments of the present disclosure. In one embodiment, a neighboring network node actively requests a neighboring cell node to share RIS, as shown in FIG. 8.

At 601: gNB2 determines whether it needs to use the RIS covered by gNB1 based on the information communicated with gNB1 in advance that can support the sharing of RIS. Based on the conditions for RIS3 to establish a normal connection, gNB2 can evaluate whether there are blind spots around RIS3 that need to be covered, and if so, gNB2 can decide to request to share RIS3.

At 602: gNB2 sends a sharing request to gNB1. The sharing request can include the identity of the RIS that requires sharing: for example, the UE ID of RIS3, the sharing mode of the target RIS: one or more desired sharing modes can be provided, and shared configuration parameters of the target RIS. For example, RIS3 is a multi-panel RIS.

The shared configuration parameters can include the number of reflective panels required to be shared. For example, if gNB1 has informed RIS3 that there are 2 reflective panels in the prior RIS communication, and there is one panel that can be shared, gNB2 can apply for sharing 1 panel.

The shared configuration parameters can include shared reflective panel identification. For example, the serial number of the panel applied for sharing can be used. The shared configuration parameters can include the configuration mode of the antenna reflection unit array of the shared reflection panel: one or more of dynamic, semi-static and static can be selected, and the codebook configuration parameter update interval can also be notified. The shared configuration parameters can include one or more of the physical parameters of the shared reflective panel or the reflecting unit array scale (e.g., the size of the reflecting unit array that needs to be used can be expressed by the number of rows and columns).

The sharing request can include, when gNB2 is using the target RIS, whether the target RIS is connected to gNB1 or gNB2 or to gNB1 and gNB2 at the same time (the RIS control module may need to support at least dual connections). The sharing request can include reflecting unit array codebook configured for the reflective panel (e.g., if multiple panels are required to be shared, the corresponding number of reflective unit array codebooks may be provided).

At 603a: gNB1 decides whether to accept the sharing request, if not, go to step 603b; if yes, feedback an acceptance message to gNB2, and confirm or modify the sharing information required by gNB2. The acceptance message can include indication of the accepted identity of one or more target RISs to be shared. In this embodiment, if gNB2's sharing request for RIS3 is accepted, the UE ID of RIS3 can be fed back to indicate confirmation. Contents of the acceptance message are described in greater detail above.

At 603b: If gNB1 does not accept the sharing request, gNB1 feeds back a RIS sharing rejection message to gNB2, which may include the reason for the rejection. For example, the reason may include that the target RIS lacks sharable resources, does not support the required sharing mode or sharing configuration parameters.

At 604: If a sharing acceptance message is received, gNB1 sends a sharing configuration message to the RIS that accepts sharing. Content of the sharing configuration message is discussed above. At 605: The RIS control plane configures the reflective panel according to the configuration message, and executes sharing.

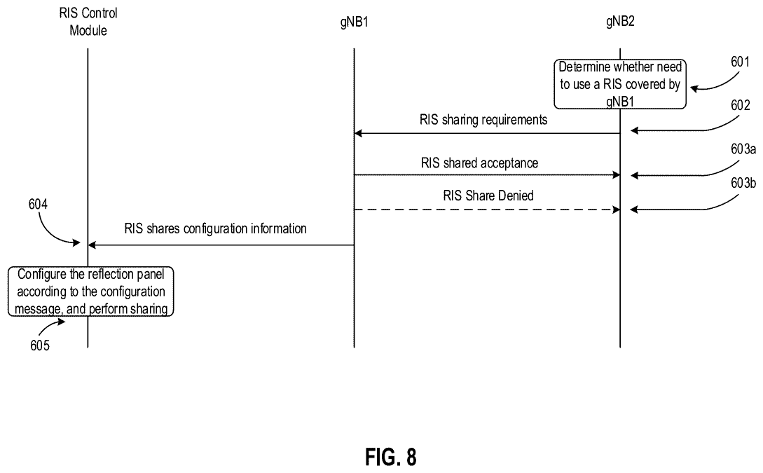

FIG. 9 illustrates a swim lane diagram of another exemplary process for initiating the process of sharing RIS between neighboring base stations, in accordance with some embodiments of the present disclosure. In one embodiment, neighboring network nodes ask neighboring nodes whether they need to share RIS, as shown in FIG. 9.

At 701: gNB1 determines whether to initiate the inquiry process based on the reference signal measurement result of gNB2 in the measurement report reported by RIS and the utilization rate of gNB1 for RIS resources. For example, if the measurement result reported by RIS3 covered by gNB1 shows its measurement the signal strength of gNB2 is sufficient, indicating that gNB2 has the basic conditions to establish a normal connection with RIS3, and gNB1 has not fully used the resources of RIS3, then gNB1 can consider initiating an inquiry process to gNB2.

At 702: gNB1 sends a RIS sharing query to gNB2 to inquire whether gNB2 has the need to share some RIS covered by gNB1. Content of the the RIS sharing query is described above. The shared configuration parameters can include shared time period information. Shared time period information is described above.

At 703a: gNB2 determines whether there is a sharing requirement, if not, go to step 703b; if yes, feedback a (acceptance) confirmation message to gNB1, and confirm or modify the sharing information provided by gNB1. The confirmation message can include confirmation of the identity of one or more target RISs to be shared. In this embodiment, if the gNB2's request for sharing of RIS3 is accepted, the UE ID of RIS3 can be fed back to indicate confirmation. Content of the (acceptance) confirmation message is described above.

At 703b: If gNB2 does not have a shared RIS requirement or does not accept the sharable resources provided by gNB1, gNB2 feeds back a RIS sharing rejection message to gNB1. Sharing rejection message is described above.

At 704: If a confirmation message is received, gNB1 sends a sharing configuration message to the RIS that accepts sharing. The sharing configuration message is described above. At 705: The RIS control plane configures the reflective panel according to the configuration message, and performs sharing.

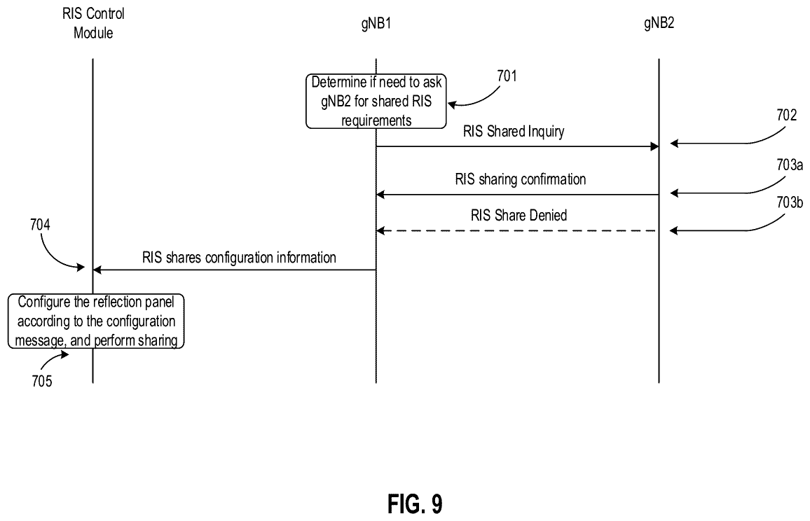

FIG. 10 illustrates a swim lane diagram of an exemplary process for base station information forwarding during sharing, in accordance with some embodiments of the present disclosure. During the RIS sharing period, gNB1 or gNB2 can decide whether to send the updated reflection unit array codebook to RIS according to needs. For example: if gNB2 decides to send the updated reflection unit array codebook to RIS, but the current RIS control module is not connected to gNB2, but connected to gNB1, gNB2 sends the updated codebook to gNB1 through the inter-base station interface, and gNB1 forwards the codebook to RIS, as shown in FIG. 10.

If the sharing mode negotiated by BS1 and BS2 requires RIS to access BS2, when RIS fails to access BS2, the failure process can be triggered, and the sharing process for the target RIS can end. The failure process is discussed above.

In an embodiment, BS1 and BS2 use time division sharing mode, frequency division sharing mode or space/air division sharing mode to share and use RIS. RIS can perform the operations according to the received time/frequency/space sharing configuration, which is discussed above.

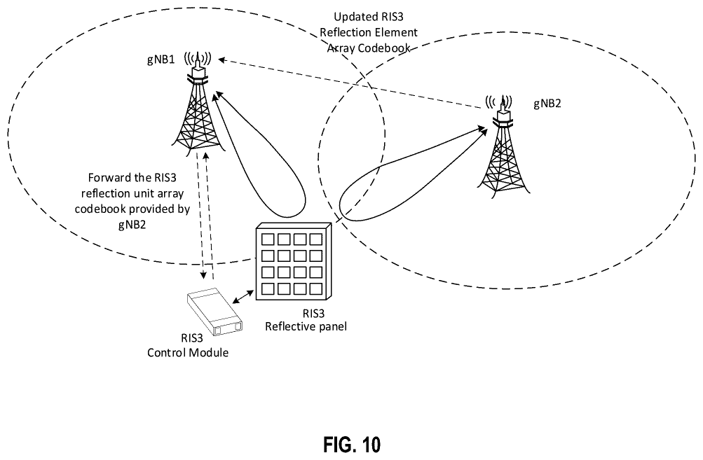

FIG. 11 illustrates a swim lane diagram of an exemplary process for modifications shared by RIS, in accordance with some embodiments of the present disclosure. After gNB1 and gNB2 have established a sharing for a certain RIS, that is, the sharing configuration parameters have been successfully issued to the RIS, and then when gNB1 or gNB2 needs to modify one of the existing sharing modes or sharing configurations of the RIS for one or more parameters, a gNB (e.g., a party of one gNB) can initiate a modification process to the other gNB (e.g., the other party's gNB). An embodiment where the RIS control module is currently connected to gNB1 is shown in FIG. 11.

At 901: gNB2 determines that the sharing configuration of RIS needs to be modified. At 902: gNB2 sends a RIS sharing modification request to gNB1, including (one or more of the following). Content of the modification request is described above.

At 903a: gNB1 determines whether to accept the modification, if not, enter step 903b to feed back a rejection message (optional, carrying the reason for rejection), if yes, gNB1 feeds back an acceptance confirmation message. The acceptance confirmation message is discussed above.

At 903b: gNB1 feeds back rejection message (optionally, carrying rejection reason). At 904: gNB1 sends updated RIS shared configuration parameters to RIS. At 905: RIS executes according to the received RIS shared configuration parameters. If gNB2 receives a sharing modification rejection message, gNB2 can choose to continue to execute according to the existing sharing configuration, or can choose to initiate a new modification process, or initiate a sharing withdrawal process.

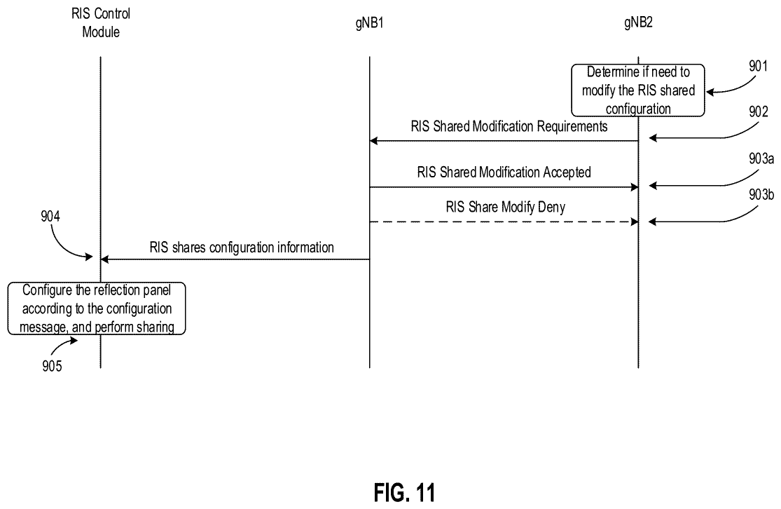

FIG. 12 illustrates a swim lane diagram of an exemplary process for withdrawal of RIS sharing, in accordance with some embodiments of the present disclosure. After gNB1 and gNB2 have established a sharing for a certain RIS, that is, the sharing configuration parameters have been successfully issued to the RIS, and then when gNB1 or gNB2 needs to suspend the pre-negotiated RIS sharing, gNB1 or gNB2 can initiate sharing to the other party. For the exit process, an embodiment where the RIS control module is currently connected to gNB1 is shown in FIG. 12.

At 1001: gNB2 is determined to terminate the existing RIS sharing. At 1002: gNB2 sends a RIS sharing withdrawal request to gNB1. The sharing withdrawal request is discussed above.

At 1003: gNB1 feeds back confirmation message. At 1004: gNB1 sends a RIS sharing exit message to the corresponding RIS. The RIS sharing exit message is described above. At 1005: RIS deletes the shared configuration parameters related to gNB2 and stops the sharing operation.

### Example 12: RIS/Repeater Sharing Example Managed by RIS/Repeater Management Function

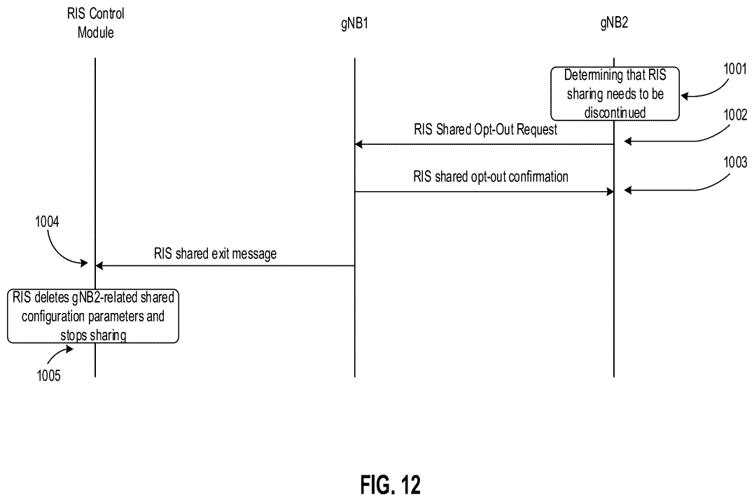

FIG. 13 illustrates a swim lane diagram of an exemplary process for commencement of RIS/repeater sharing, in accordance with some embodiments of the present disclosure. The network operator can load the RIS/Repeater management function in the OAM (Operation, Administration and Maintenance) background of the RAN (Radio Access Network) access network to manage the RISs or Repeaters within the coverage of gNB1 and gNB2. RIS or Repeater can be shared by gNB1 and gNB2, and can directly issue shared configuration to gNB1 and gNB2, as shown in FIG. 13.

At 1101a/b: the RIS/Repeater manager generates a shared configuration for a certain target RIS or Repeater in the RIS/Repeater management function, and the target RIS or Repeater is shared and used by gNB1 and gNB2, wherein the control module of the target RIS or Repeater currently camps on gNB1 (the control module of the target RIS or Repeater may be in RRC connected state, IDLE state or Inactive state). The RIS/Repeater management function can send the generated shared configuration to gNB1 and gNB2 respectively.

At 1102: since the target RIS or Repeater camps on gNB1, gNB1 sends the received shared configuration to the target RIS or Repeater; if the target RIS or Repeater is in the RRC connection state, gNB1 can directly transmit the shared configuration to the target through the traffic channel or signaling. The RIS or Repeater can deliver the shared configuration; if the target RIS or Repeater is in the RRC idle/inactive state, gNB1 can wake up the target RIS or Repeater through paging, and then deliver the shared configuration;

At 1103: the target RIS or Repeater receives the shared configuration, and if the configuration does not exceed the capabilities of the target RIS or Repeater, it can send back a configuration completion or confirm message to gNB1. At 1104: gNB1 receives the configuration confirm message of the target RIS or Repeater, and feeds back the shared configuration confirm message to the RIS/Repeater management function.

At 1105: if gNB2 supports the received shared configuration and feeds back a configuration acceptance message to the RIS/Repeater management function. At 1106: according to the sharing mode start time and sharing parameters in the sharing configuration, the RIS/Repeater and the gNB1/2 execute the sharing mode.

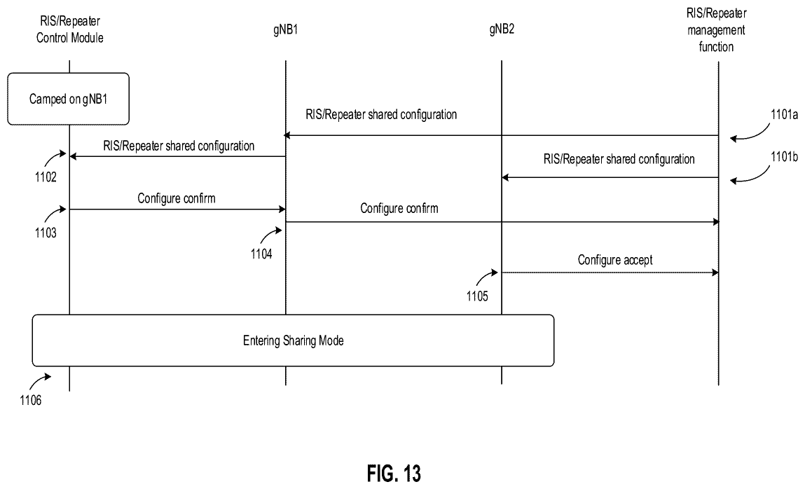

FIG. 14 illustrates a method 1400 for sharing a reflection-based communication element, in accordance with some embodiments. Referring to FIGS. 1-13, the method 1400 can be performed by a wireless communication device (e.g., a UE) and/or a wireless communication node (e.g., base station, a gNB), in some embodiments. Additional, fewer, or different operations may be performed in the method 1400 depending on the embodiment.

At operation 1410, in some embodiments, a first wireless communication node and a second wireless communication node share a reflection-based communication element. In some embodiments, the first wireless communication node is BS2 (e.g., gNB2), the second wireless communication node is BS1 (e.g., gNB1), and the reflection-based communication element is the RIS control module.

In some embodiments, the first wireless communication node sends, to the second wireless communication node, a first message requesting to share the reflection-based communication element.

In some embodiments, the first wireless communication node receives, from the second wireless communication node, a second message inquiring whether the first wireless communication node needs to share the reflection-based communication element. In some embodiments, the first message includes at least one of: respective identifiers of one or more reflection-based communication elements; a sharing mode of the reflection-based communication element; configuration parameters associated with the sharing mode; whether the reflection-based communication element camps on only the second wireless communication node, only the first wireless communication node, or both of the first and second wireless communication nodes, when the first wireless communication node uses the reflection-based communication element; an indication that the reflection-based communication element camps on any of the first or second wireless communication node that is using the reflection-based communication element; or a codebook configured for phases of a reflecting unit array of the reflection-based communication element.

In some embodiments, the first wireless communication node receives, from the second wireless communication node, a third message acknowledging the request in the first message. In some embodiments, the third message indicates at least one of: identifiers of one or more allowed reflection-based communication elements; identifiers of one or more refused reflection-based communication elements optionally together with a reason for the refusal; a sharing mode of the reflection-based communication element being allowed or modified; configuration parameters associated with the sharing mode; whether the reflection-based communication element camps on only the second wireless communication node, only the first wireless communication node, or both of the first and second wireless communication nodes, when the first wireless communication node uses the reflection-based communication element; or an indication that the reflection-based communication element camps on any of the first or second wireless communication node that is using the reflection-based communication element.

In some embodiments, the second wireless communication node sends, to the reflection-based communication element which allows to be shared, a fourth message including sharing configuration information. In some embodiments, the sharing configuration information includes at least one of: respective identifiers of the first and/or second wireless communication node; a sharing mode of the reflection-based communication element; configuration parameters associated with the sharing mode; whether the reflection-based communication element camps on only the second wireless communication node, only the first wireless communication node, or both of the first and second wireless communication nodes, when the first wireless communication node uses the reflection-based communication element; an indication that the reflection-based communication element camps on any of the first or second wireless communication node that is using the reflection-based communication element; a first codebook that the first wireless communication node configures for phases of a reflecting unit array of the reflection-based communication element; or a second codebook that the second wireless communication node configures for phases of a reflecting unit array of the reflection-based communication element.

In some embodiments, the second message includes at least one of: respective identifiers of one or more reflection-based communication elements; a sharing mode of the reflection-based communication element; configuration parameters associated with the sharing mode; whether the reflection-based communication element camps on only the second wireless communication node, only the first wireless communication node, or both of the first and second wireless communication nodes, when the second wireless communication node uses the reflection-based communication element; an indication that the reflection-based communication element camps on any of the first or second wireless communication node that is using the reflection-based communication element; or a codebook configured for phases of a reflecting unit array of the reflection-based communication element.

In some embodiments, the first wireless communication node sends, to the second wireless communication node, a fifth message acknowledging the inquiry in the second message. In some embodiments, the fifth message indicates at least one of: identifiers of one or more reflection-based communication elements being selected by the first wireless communication node; a sharing mode of the reflection-based communication element being selected by the first wireless communication node; configuration parameters associated with the sharing mode; whether the reflection-based communication element camps on only the second wireless communication node, only the first wireless communication node, or both of the first and second wireless communication nodes, when the second wireless communication node uses the reflection-based communication element; an indication that the reflection-based communication element camps on any of the first or second wireless communication node that is using the reflection-based communication element; or a codebook that the first wireless communication node configures for phases of a reflecting unit array of the reflection-based communication element.

In some embodiments, the second wireless communication node sends, to the reflection-based communication element which allows to be shared, a sixth message including sharing configuration information. In some embodiments, the sharing configuration information includes at least one of: respective identifiers of the first and/or second wireless communication nodes; a sharing mode of the reflection-based communication element; configuration parameters associated with the sharing mode; whether the reflection-based communication element camps on only the second wireless communication node, only the first wireless communication node, or both of the first and second wireless communication nodes, when the first wireless communication node uses the reflection-based communication element; an indication that the reflection-based communication element camps on any of the first or second wireless communication node that is using the reflection-based communication element; a first codebook that the first wireless communication node configures for phases of a reflecting unit array of the reflection-based communication element; or a second codebook that the second wireless communication node configures for phases of a reflecting unit array of the reflection-based communication element.

In some embodiments, the configuration parameters include at least one of: a plurality of first configuration parameters for time division multiplexing; a plurality of second configuration parameters for frequency division multiplexing; or a plurality of third configuration parameters for space division multiplexing. In some embodiments, the first configuration parameters include at least one of: a periodic sharing time defined by at least one of: a cycle length, a shared time length in each cycle, a starting of the shared time in each cycle; a non-periodic sharing time defined by at least one of: a starting time and an end time, or by a starting time and a time length; or a starting time or a starting time offset of a sharing action.

In some embodiments, the second configuration parameters include at least one of: a frequency band during which the reflection-based communication element is shared; or a reflecting unit array of the reflection-based communication element that corresponds to the shared frequency band. In some embodiments, the third configuration parameters include identifiers of shared reflecting panels of the reflection-based communication element.

In some embodiments, the first wireless communication node or the second wireless communication node determines to send, to the reflection-based communication element, an updated codebook configured for phases of a reflecting unit array of the reflection-based communication element. In some embodiments, the first wireless communication node or the second wireless communication node determines to send, when the reflection-based communication element does not camp on the first wireless communication node generating an updated codebook, to the second wireless communication node camped on by the reflection-based communication element, the updated codebook. In some embodiments, the first wireless communication node or the second wireless communication node determines to send, to the reflection-based communication element, the updated codebook.

In some embodiments, the second wireless communication node receives, in response to a failure of an accessing procedure or connection setup procedure from the reflection-based communication element to the first wireless communication node, from the reflection-based communication element or the first wireless communication node, a seventh message indicating the failure, optionally with a reason for the failure. In some embodiments, the first or second wireless communication node receives, in response to a failure that the reflection-based communication element fails to receive or cannot support sharing configuration parameters sent by the first or second wireless communication node, from the reflection-based communication element, an eighth message indicating the failure, optionally with a reason for the failure.

In some embodiments, a step of the first wireless communication node configuring sharing configuration parameters for the reflection-based communication element was successful. In some embodiments, the first wireless communication node sends, in response to not receiving access from a wireless communication device within a coverage of the reflection-based communication element, to the second wireless communication node, a reason for the failure, thereby causing the step of sharing to be terminated.

In some embodiments, prior to the step of sharing a reflection-based communication element, the first or second wireless communication node obtain a sharing capability of the reflection-based communication element from the reflection-based communication element or a core network device. In some embodiments, the sharing capability includes at least one of: a type of the reflection-based communication element, or one or more sharing modes of the reflection-based communication element.

In some embodiments, prior to the step of sharing a reflection-based communication element, the second wireless communication node receives, from the first wireless communication node, a tenth message indicating first information of the reflection-based communication element that is associated with a coverage of the first wireless communication node. In some embodiments, prior to the step of sharing a reflection-based communication element, the second wireless communication node sends, to the first wireless communication node, an eleventh message indicating second information of the reflection-based communication element that is associated with a coverage of the second wireless communication node.

In some embodiments, the first information and the second information each include at least one of: an identifier of the reflection-based communication element; a type of the reflection-based communication element; a location of the reflection-based communication element; a sharing mode of the reflection-based communication element; an operating state of reflecting panels of the reflection-based communication element; available resources of the reflection-based communication element; or a measurement result reported by the reflection-based communication element.

In some embodiments, concurrently with the step of sharing a reflection-based communication element, the second wireless communication node receives, from the first wireless communication node, a twelfth message requesting to modify sharing configuration of the shared reflection-based communication element. In some embodiments, concurrently with the step of sharing a reflection-based communication element, the second wireless communication node sends, to the first wireless communication node, a thirteenth message indicating whether the request is accepted or refused.

In some embodiments, the twelfth message includes at least one of: a respective identifier of one or more shared reflection-based communication elements whose sharing configuration needs to be modified; a modified sharing configuration of a respective shared reflection-based communication element; or a modification reason of respective shared reflection-based communication element.

In some embodiments, the second wireless communication node receives from the first wireless communication node, a fourteenth message requesting to terminate sharing the reflection-based communication element with the first wireless communication node. In some embodiments, the second wireless communication node sends, to the first wireless communication node, a fifteenth message indicating whether the request is accepted or refused. In some embodiments, the second wireless communication node sends, to the reflection-based communication element, a sixteenth message indicating the termination.

In some embodiments, the fourteenth message further includes an identifier of the shared reflection-based communication element that is requested to be terminated, and optionally a reason for the termination. In some embodiments, the sixteenth message further includes an identifier of the first wireless communication node, and optionally an updated codebook configured for phases of a reflecting unit array of the reflection-based communication element.

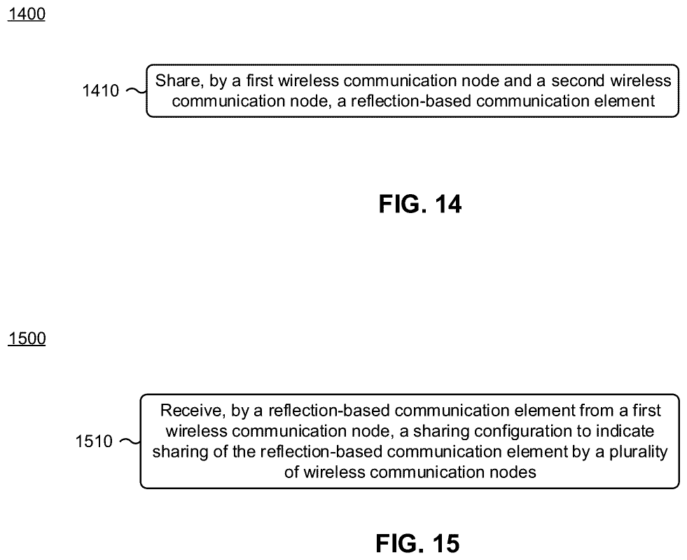

FIG. 15 illustrates a method 1500 for receiving a sharing configuration to indicate sharing of a reflection-based communication element, in accordance with some embodiments. Referring to FIGS. 1-13, the method 1500 can be performed by a wireless communication device (e.g., a UE) and/or a wireless communication node (e.g., base station, a gNB), in some embodiments. Additional, fewer, or different operations may be performed in the method 1500 depending on the embodiment.

At operation 1502, in some embodiments, a reflection-based communication element receives, from a first wireless communication node, a sharing configuration to indicate sharing of the reflection-based communication element by a plurality of wireless communication nodes. In some embodiments, the reflection-based communication element is the RIS/repeater control module and the first wireless communication node is BS1 (e.g., gNB1). In some embodiments, the plurality of wireless communication nodes includes BS1 and BS2 (e.g., gNB2).

In some embodiments, the first wireless communication node receives the sharing configuration from a management function. In some embodiments, the management function is the RIS/repeater management function.

In some embodiments, the sharing configuration includes at least one of: an identifier of the shared reflection-based communication element; a respective identifier of the plurality of wireless communication nodes that can share the reflection-based communication element; a sharing mode; configuration parameters associated with the sharing mode; which of the wireless communication nodes is camped on by the reflection-based communication element during the sharing; or one or more codebooks configured for phases of a reflecting unit array of the reflection-based communication element by the wireless communication nodes that can share the reflection-based communication element.

In some embodiments, the sharing mode is configured as one of: time division multiplexing; frequency division multiplexing; or space division multiplexing. In some embodiments, the configuration parameters associated with the time division multiplexing sharing mode include at least one of: a periodic sharing time defined by at least one of: a cycle length, a shared time length in each cycle, a starting of the shared time in each cycle; a non-periodic sharing time defined by at least one of: a starting time and an end time, or by a starting time and a time length; or a starting time or a starting time offset of a sharing action.

In some embodiments, the configuration parameters associated with the frequency division multiplexing sharing mode include at least one of: a frequency band during which the reflection-based communication element is shared; or a reflecting unit array of the reflection-based communication element that corresponds to the shared frequency band.

In some embodiments, the configuration parameters associated with the space division multiplexing sharing mode includes identifiers of shared reflecting panels of the reflection-based communication element. In some embodiments, which the reflection-based communication element camps on a second one of the wireless communication nodes that is using the reflection-based communication element.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method, comprising:
sharing, by a first wireless communication node and a second wireless communication node, a reflection-based communication element,
wherein the reflection-based communication element comprises a reflecting unit array.

2. The wireless communication method of claim 1, further comprising:
sending, by the first wireless communication node to the second wireless communication node, a first message requesting to share the reflection-based communication element.

3. The wireless communication method of claim 1, further comprising:
receiving, by the first wireless communication node from the second wireless communication node, a second message inquiring whether the first wireless communication node needs to share the reflection-based communication element.

4. The wireless communication method of claim 2, wherein the first message comprises at least one of:
respective identifiers of one or more reflection-based communication elements;
a sharing mode of the reflection-based communication element;
configuration parameters associated with the sharing mode;
an indication of whether the reflection-based communication element camps on only the second wireless communication node, only the first wireless communication node, or both of the first and second wireless communication nodes, when the first wireless communication node uses the reflection-based communication element;
an indication that the reflection-based communication element camps on any of the first or second wireless communication node that is using the reflection-based communication element; or
a codebook configured for phases of the reflecting unit array of the reflection-based communication element.

5. The wireless communication method of claim 2, further comprising:
receiving, by the first wireless communication node from the second wireless communication node, a third message acknowledging the request in the first message.

6. The method of claim 5, wherein the third message indicates at least one of:
identifiers of one or more allowed reflection-based communication elements;
identifiers of one or more refused reflection-based communication elements optionally together with a reason for the refusal;
a sharing mode of the reflection-based communication element being allowed or modified;
configuration parameters associated with the sharing mode;
whether the reflection-based communication element camps on only the second wireless communication node, only the first wireless communication node, or both of the first and second wireless communication nodes, when the first wireless communication node uses the reflection-based communication element; or
an indication that the reflection-based communication element camps on any of the first or second wireless communication node that is using the reflection-based communication element.

7. The wireless communication method of claim 2, wherein the second wireless communication node sends, to the reflection-based communication element which allows to be shared, a fourth message comprising sharing configuration information that comprises at least one of:
respective identifiers of the first and/or second wireless communication node;
a sharing mode of the reflection-based communication element;
configuration parameters associated with the sharing mode;
an indication of whether the reflection-based communication element camps on only the second wireless communication node, only the first wireless communication node, or both of the first and second wireless communication nodes, when the first wireless communication node uses the reflection-based communication element;
an indication that the reflection-based communication element camps on any of the first or second wireless communication node that is using the reflection-based communication element;
a first codebook that the first wireless communication node configures for phases of the reflecting unit array of the reflection-based communication element; or
a second codebook that the second wireless communication node configures for phases of the reflecting unit array of the reflection-based communication element.

8. The wireless communication method of claim 3, wherein the second message comprises at least one of:
respective identifiers of one or more reflection-based communication elements;
a sharing mode of the reflection-based communication element;
configuration parameters associated with the sharing mode;
an indication of whether the reflection-based communication element camps on only the second wireless communication node, only the first wireless communication node, or both of the first and second wireless communication nodes, when the second wireless communication node uses the reflection-based communication element;
an indication that the reflection-based communication element camps on any of the first or second wireless communication node that is using the reflection-based communication element; or
a codebook configured for phases of the reflecting unit array of the reflection-based communication element.

9. The wireless communication method of claim 8, further comprising:
sending, by the first wireless communication node to the second wireless communication node, a fifth message acknowledging the inquiry in the second message.

10. The wireless communication method of claim 9, wherein the fifth message indicates at least one of:
identifiers of one or more reflection-based communication elements being selected by the first wireless communication node;
a sharing mode of the reflection-based communication element being selected by the first wireless communication node;
configuration parameters associated with the sharing mode;
whether the reflection-based communication element camps on only the second wireless communication node, only the first wireless communication node, or both of the first and second wireless communication nodes, when the second wireless communication node uses the reflection-based communication element;
an indication that the reflection-based communication element camps on any of the first or second wireless communication node that is using the reflection-based communication element; or
a codebook that the first wireless communication node configures for phases of the reflecting unit array of the reflection-based communication element.

11. The wireless communication method of claim 3, wherein the second wireless communication node sends, to the reflection-based communication element which allows to be shared, a sixth message comprising sharing configuration information that comprises at least one of:
respective identifiers of the first and/or second wireless communication nodes;
a sharing mode of the reflection-based communication element;
configuration parameters associated with the sharing mode;
an indication of whether the reflection-based communication element camps on only the second wireless communication node, only the first wireless communication node, or both of the first and second wireless communication nodes, when the first wireless communication node uses the reflection-based communication element;
an indication that the reflection-based communication element camps on any of the first or second wireless communication node that is using the reflection-based communication element;
a first codebook that the first wireless communication node configures for phases of the reflecting unit array of the reflection-based communication element; or
a second codebook that the second wireless communication node configures for phases of the reflecting unit array of the reflection-based communication element.

12. The wireless communication method of claim 4, wherein the configuration parameters comprise at least one of:
a plurality of first configuration parameters for time division multiplexing;
a plurality of second configuration parameters for frequency division multiplexing; or
a plurality of third configuration parameters for space division multiplexing.

13. The wireless communication method of claim 12, wherein the first configuration parameters comprise at least one of:
a periodic sharing time defined by at least one of: a cycle length, a shared time length in each cycle, or a starting of the shared time in each cycle;
a non-periodic sharing time defined by at least one of: a starting time and an end time, or a starting time and a time length; or
a starting time or a starting time offset of a sharing action.

14. The wireless communication method of claim 12, wherein the second configuration parameters comprise at least one of:
a frequency band during which the reflection-based communication element is shared; or
the reflecting unit array of the reflection-based communication element that corresponds to the shared frequency band.

15. The wireless communication method of claim 12, wherein the third configuration parameters comprise identifiers of shared reflecting panels of the reflection-based communication element.

16. The wireless communication method of claim 1, further comprising:
determining, by the first wireless communication node or the second wireless communication node, to send, to the reflection-based communication element, an updated codebook configured for phases of the reflecting unit array of the reflection-based communication element;
when the reflection-based communication element does not camp on the first wireless communication node generating an updated codebook, sending, by the first wireless communication node to the second wireless communication node camped on by the reflection-based communication element, the updated codebook; and
sending, by the second wireless communication node to the reflection-based communication element, the updated codebook.

17. The wireless communication method of claim 1, further comprising:
in response to a failure of an accessing procedure or connection setup procedure from the reflection-based communication element to the first wireless communication node, receiving, by the second wireless communication node from the reflection-based communication element or the first wireless communication node, a seventh message indicating the failure, optionally with a reason for the failure; or
in response to a failure that the reflection-based communication element fails to receive or cannot support sharing configuration parameters sent by the first or second wireless communication node, receiving, by the first or second wireless communication node from the reflection-based communication element, an eighth message indicating the failure, optionally with a reason for the failure.

18. The wireless communication method of claim 1, wherein when a step of the first wireless communication node configuring sharing configuration parameters for the reflection-based communication element was successful, the wireless communication method further comprises:
in response to not receiving access from a wireless communication device within a coverage of the reflection-based communication element, sending, by the first wireless communication node to the second wireless communication node, a reason for the failure, thereby causing the step of sharing to be terminated.

19. The wireless communication method of claim 1, prior to the step of sharing a reflection-based communication element, further comprising:
obtaining, by the first or second wireless communication node, a sharing capability of the reflection-based communication element from the reflection-based communication element or a core network device.

20. A first wireless communication node, comprising:
at least one processor configured to share, with a second wireless communication node, a reflection-based communication element,
wherein the reflection-based communication element comprises a reflecting unit array.
